(19) United States
(12) Patent Application Publication
(10) Pub. No.: US 2026/0320835 A1
(43) Pub. Date: Oct. 15, 2026

(54) Method and Device for Operating a Camera System

(71) Applicants: Robert Bosch GmbH, Stuttgart (DE); CARIAD SE, Wolfsburg (DE)

(72) Inventor: Christopher Herbon, Stuttgart (DE)

(21) Appl. No.: 19/642,859

(22) Filed: Apr. 9, 2026

(30) Foreign Application Priority Data
Apr. 11, 2025 (DE) 10 2025 114 295.5

(51) Int. Cl. G06T 7/80; G06V 10/44; G06V 10/75

(52) U.S. Cl. CPC G06T 7/80; G06V 10/44; G06V 10/751; G06T 2207/20081; G06T 2207/30252

(57) ABSTRACT

A method is for operating a camera system of a work system. The camera system includes at least one camera device arranged on the work system. The method includes capturing at least one image using the at least one camera device, and detecting a detected contour in the at least one image as being stationary relative to the at least one camera device. The method also includes projecting the detected contour onto a spherical surface, determining a comparison by comparing the detected contour to a reference contour projected onto the spherical surface, and calibrating the at least one camera device based on the comparison.

This application claims priority under 35 U.S.C. § 119 to patent application no. DE 10 2025 114 295.5, filed on Apr. 11, 2025 in Germany, the disclosure of which is incorporated herein by reference in its entirety.

The disclosure relates to a method for operating a camera system of a movable work system, in particular a motor vehicle or robot, with at least one camera device arranged on the work system, wherein at least one image is captured by means of the camera device, wherein the image is used for calibration of the camera system.

Furthermore, the disclosure relates to a control unit, which is specifically configured to perform the above-mentioned method, as well as to a camera system with such a control unit.

### BACKGROUND

In order to be able to safely utilize camera systems in movable work systems, such as motor vehicles and robots or the like, it is important that they be calibrated or are calibrated. In the case of motor vehicles, a first calibration is usually carried out during the manufacture of the motor vehicle, which allows the best possible calibration of the camera device of the camera system. Often, test recordings are taken in a predefined environment and compared to expected results to calibrate the camera device as needed for the test recording to match the expected result. However, the calibration once performed may change over time. For example, the position and/or orientation of the camera may be altered with time by vibrations, oscillations, and/or even unexpected external forces. The camera device may also change its position and/or orientation, depending on environmental factors, for example the ambient temperature. It is therefore also known to perform the calibration again at a later time in order to detect unwanted deviations early. Recalibration during normal driving operation of the motor vehicle is referred to as online calibration.

Generally, the calibration may relate to both the intrinsic and extrinsic parameters of the camera device. The intrinsic parameters are in particular understood to mean the projection properties of the camera device, while the extrinsic parameters are in particular understood to mean the orientation and position of the camera device, in particular in relation to a fixed coordinate system in relation to the motor vehicle. In particular, the rotation parameters or angles of the camera device, i.e., pitch angle, roll angle and yaw angle, affect the extrinsic parameters. While translational shifting of the position of the camera device results in a negligible change in the evaluation of the images captured by the camera device, a change in the rotation angle can lead to far greater consequences in the image evaluation.

For example, work with image correspondences for calibration has been known. For this purpose, correspondences between the different recordings are determined in several consecutively recorded images in order to capture matches and deviations, on the basis of which the calibration can be carried out. In particular, optical flow methods or image comparison methods are currently used.

### SUMMARY

The method according to the disclosure has the advantage that the calibration of the camera device is reliably performed with simple aids. The method can be carried out at any time, i.e., also as an online calibration, so that a review of the calibration of the camera device can take place regularly and frequently in order to be able to detect deviations at any time. The method according to the disclosure provides that a contour detected in the image of the camera device as being stationary relative to the camera is determined and projected onto a spherical surface, and that the detected contour is compared to a reference contour on the spherical surface, and that the camera device is calibrated as a function of the comparison. The disclosure thus makes use of the fact that areas of a housing of the work system, in particular a body of the motor vehicle, are often also located in the image area of the camera device. By detecting these housing or body areas or sections and in particular their contour, a contour that is at least theoretically always the same in the image captured by the camera device is available, which is advantageously used to calibrate the camera device. In particular, the contour is a contour that defines the transition between the housing or the body and the environment from the perspective of the camera device. If the detected contour deviates from the reference contour on the spherical surface beyond a specified tolerance value, the contour can be made to match the reference contour by changing the pitch angle, roll angle, and/or yaw angle, and the calibration of the camera device can thereby be carried out in an advantageous manner. The angle changes necessarily made for this purpose are preferably stored as calibration values and enable safe use of the camera device. Preferably, the angle changes are compared with specifiable threshold values, wherein if a threshold value is exceeded, an error or warning message is preferably output, which results in the camera device being serviced or replaced at the next repair shop visit, for example. In particular, the intrinsic parameters of the camera device are taken into account when projecting the contour onto the spherical surface. The projection onto the virtual spherical surface has the advantage that the course of the contour in the image may differ depending on different orientations of the camera device; this results in particular from the projection parameters of the lens of the camera device. Advantageously, the projection is performed pixel by pixel such that a point is projected onto the spherical surface for each pixel of the image. Preferably, a continuous line is drawn through the individual points, which represents the contour line or the detected contour. The disclosure also has the advantage, among other things, that the orientation of the camera device with respect to the housing or the body of the work system is directly sensed, and that the method is independent of the shape, or at least substantially independent of the shape, of the detected contour. In contrast to known methods, no restrictions with regard to the movement of the work system need to be taken into account. Thus, it is not important for the work system to be moved at a predetermined and/or constant speed. Rather, the method according to the disclosure also results in an advantageous calibration result when the work system is stationary.

According to a preferred further development of the disclosure, a predetermined contour is detected as a stationary contour in the image of the camera. The method provides that the contour is previously known and is available in this respect as a comparison contour. To perform the method, the image is checked for whether the comparison contour is contained therein. This is done, for example, by means of a conventional image comparison method. If the predetermined contour is detected in the image, its position in the image can be determined, and the calibration of the camera device can thereby be performed advantageously as a function of an expected position of the contour.

Particularly preferably, a housing or body contour of the work system captured in the image is selected as the predetermined contour. For this purpose, the image is evaluated in particular for the presence of any housing or body contour. This is particularly recognized as the boundary line between moving pixels and stationary pixels in the image.

According to a preferred embodiment of the disclosure, different image areas are detected, and in particular classified, by means of a trained deep learning method, in particular using semantic segmentation, and the stationary contour is determined as the boundary between at least two of the adjacent image areas. A single image recording is sufficient for this purpose. By means of the deep learning method, various image areas, such as body, road, pedestrian path, houses, trees, road boundary, sky, and the like, are recognized and classified as such. In the next step, the boundary or transition between the body and the remaining areas, particularly the road and the sidewalk, is then determined as the stationary contour of the body. Preferably, image edges of the image that are caused, for example, by a lens, in particular a fisheye lens of the camera device, are ignored as edge contours.

According to a further embodiment of the disclosure, a plurality of images are preferably captured by means of the camera device, and by comparing the pixels of the plurality of images with one another, stationary pixels are differentiated from moving pixels, and a series of stationary pixels adjacent to moving pixels is detected as the stationary contour. In particular, the series of fixed pixels that are adjacent to an area of moving pixels is recognized as the stationary contour. Thus, the contour represents the boundary line between the moving image area of the image and the stationary area of the pixel, wherein the latter is defined by the body or the housing of the work system.

Preferably, by comparing the captured contour with the specified contour, a pitch angle, roll angle, and/or yaw angle of the camera device is determined and used to calibrate the camera device with associated target values.

In particular, the captured contour and the reference contour are made to match on the spherical surface by changing the pitch angle, the roll angle, and/or the yaw angle to calibrate the camera device. Preferably, a non-linear optimization, in particular a Levenberg-Marquardt method comprising an algorithm for least square estimation of non-linear parameters, is used to adjust the contours to each other.

Preferably, prior to calibration, the shape of the detected contour is checked and the calibration aborted, if the shape of the detected contour is a circular shape. The circular shape has the disadvantage that not all angles/rotation angles can be captured. In such a case, either the comparison or the calibration is therefore limited to a selected group of rotation angles, or the calibration result in total is discared.

The control unit according to the disclosure is characterized by a control unit that is specifically configured to perform the method according to the disclosure, when used as intended. The control unit is also referred to as a control system that includes a corresponding processor configured to perform the method according to the disclosure. The advantages specified above are achieved as a result.

The camera system according to the disclosure is characterized by the control unit according to the disclosure. The advantages specified above are achieved as a result.

### BRIEF DESCRIPTION OF THE DRAWINGS

Further advantages and preferred features and combinations of features result in particular from the previous descriptions and from the claims. The disclosure will be explained in more detail below with reference to the drawings. Shown are:

FIG. 1 shows a motor vehicle with an advantageous camera system in a simplified illustration,

FIGS. 2A and 2B show images of the camera system,

FIG. 3 shows an advantageous detected contour of the motor vehicle, and

FIG. 4 shows a projection of the detected contour onto a spherical surface and comparison with a reference contour for calibration of the camera system.

### DETAILED DESCRIPTION

FIG. 1 shows, in a simplified perspective illustration, an advantageous movable work system 1 in the form of a motor vehicle with an advantageous camera system 2. According to the present exemplary embodiment, the camera system 2 comprises a camera device 3, which is fixedly arranged in the area of a vehicle roof. Further shown are the coordinate system X-Y-Z of the motor vehicle as well as a yaw angle Ψ, a pitch angle θ, and a roll angle Φ of the camera device 3, relative to the coordinate system of the motor vehicle. In addition, the work system 1, in particular the camera system 2, comprises a control unit 4, which performs the method described below.

In summary, the method comprises the following steps:
Step 1: Capturing the body of the motor vehicle in the image of the camera device 3.
Step 2: Detecting a contour of the body.
Step 3: Projecting the contour/points onto a virtual spherical surface.
Step 4: Connecting the pixels by means of a line.
Step 5: Calibrating the pitch angle, roll angle, and yaw angle to obtain the best-possible match between the detected contour and a reference contour.
Step 6: (Optional) long-term monitoring of the determined angles.

In step 1, the method thus provides that a contour of the body is detected in the image of the camera device 3. This contour, which is in this respect stationary with respect to the camera device, serves as a reference for assessing the orientation of the camera device 3.

The stationary contour of the body particularly represents the transition between the stationary body and the environment of the motor vehicle. To determine this contour, various steps may be performed:

According to an exemplary embodiment, a deep learning-based semantic segmentation is performed, in which a particular label is assigned to each area of the captured image. A classification of the image areas detected in the image is thus carried out. For example, image areas representing the body may be differentiated from image areas that represent the environment, for example, a road, a pedestrian path, houses, trees, or the like.

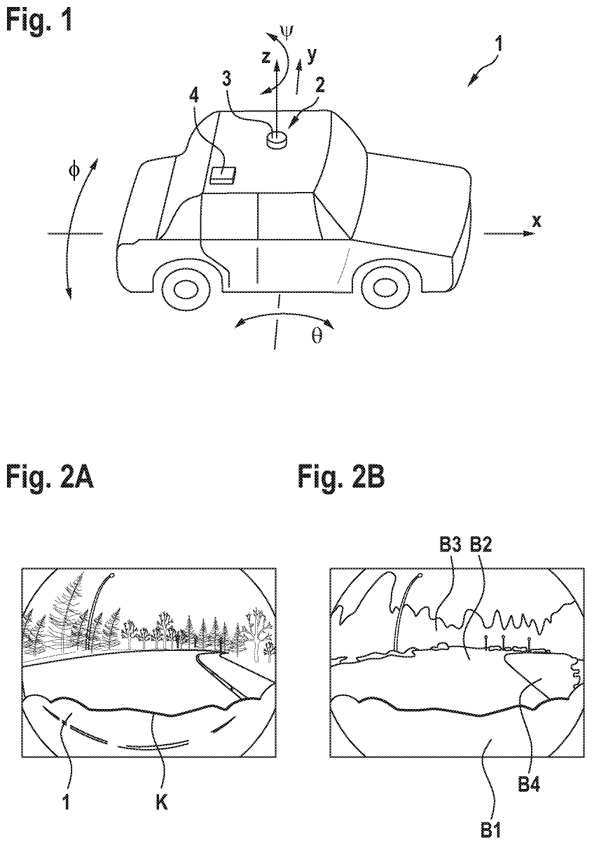

FIG. 2A shows, by way of example, an image of the camera device 3 comprising a fisheye lens. The contour of the body, which shows the transition to the environment, is exemplarily traced by a line in the present case.

FIG. 2B exemplarily shows the result of semantic segmentation, in which different image areas of the camera image were assigned different classes. Image area B1 was thereby assigned the class motor vehicle or body. Image area B2 was assigned the class road, image area B3 the class environment, and image area B4 the class pedestrian path. Using the deep learning algorithm, these classes can be reliably and quickly assigned, thereby classifying the image content.

According to an alternative exemplary embodiment, an image comparison algorithm searches for a predetermined or previously known contour of the body in the camera image and thereby detects it. According to a further exemplary embodiment, the image is divided into moving and stationary regions to capture the contour K.

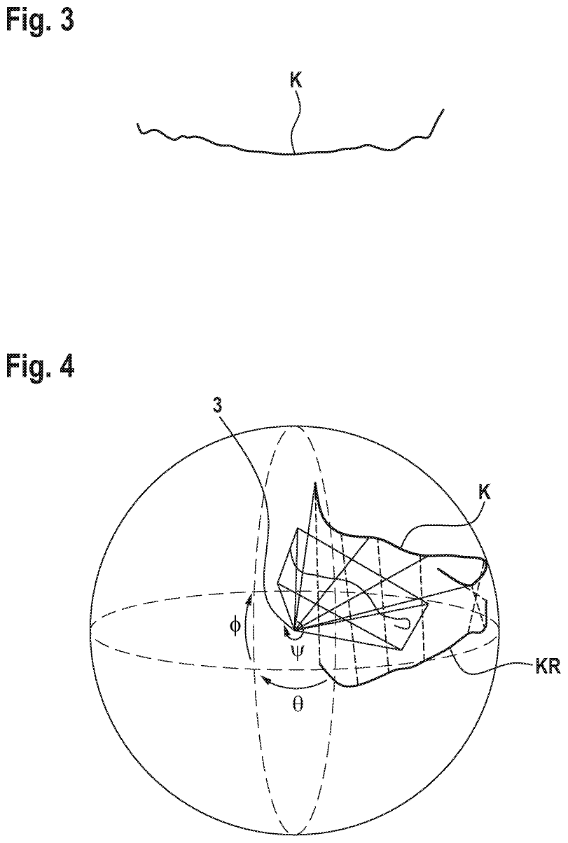

FIG. 3 exemplifies the contour K detected in step 2. In particular, the contour K is detected as the boundary line between the body according to region B1 and the remaining regions B2, B3 and B4.

Preferably, boundary areas B5 of the camera image resulting from, for example, the fisheye lens of the camera device, and which therefore appear black in the actual camera image and likewise are adjacent to the regions B1 to B4, are ignored when determining the contour K.

In the following step 3, the detected contour is projected onto a virtual spherical surface, in particular taking into account the intrinsic parameters of the camera device 3, which are assumed to be known.

FIG. 4 shows the projection onto the spherical surface, for example. In the projection, it is assumed that the camera device 3 lies in the center of the sphere. The advantage of the projection on the spherical surface is that the shape of the contour K from the image can lead to different projections on the spherical surface as a function of the orientation of the camera device 3. Thus, the camera properties can be taken into account in an advantageous manner, and a clear calibration can be achieved. The projection is performed in particular in such a way that an image point is projected onto the spherical surface for each pixel of the camera device. Then, a line from the center of the camera device is passed through the pixel of the camera image, and the intersection of that line with the spherical surface is determined, and the spherical coordinates at the intersection are stored.

Once the contour is projected onto the spherical surface in the form of the pixels mentioned above, a line is passed through the points in step 4. This further development allows for continuous sampling, which is advantageous for non-linear optimization in the following step, since it cannot be assumed that the points in the image are well-suited for the sampling of the curve.

In the following step 5, the detected contour K projected onto the spherical surface is compared with a reference contour KR. For example, the contours K and KR have been recorded with the same camera device 3, but at different points in time. For example, the reference contour KR has been determined as a stationary contour during the initialization of the camera system 2 by means of the method described above and stored as a reference contour.

It can be seen in FIG. 4 that the two contours K and KR are not lying on top of one another. This results because of the camera device having become decalibrated over time, such that the current orientation of the camera device 3 no longer corresponds to the original orientation of the camera device 3.

The contours K and KR are therefore preferably aligned with each other in step 5 by means of a non-linear optimization, in particular such that they overlap each other or at least match to the greatest extent possible. This is achieved, for example, by employing an algorithm for least squares estimation of non-linear parameters. For this purpose, the rotation parameters are changed by correction values until the contours match. The necessary correction values of the rotation parameters, i.e., pitch angle, roll angle and yaw angle, are saved and used to either physically correct the orientation of the camera device or to correct images captured during the subsequent use of the camera system according to the correction values prior to their evaluation. This ensures that even when the camera device 3 is decalibrated, the recorded images can be safely used for further applications of the motor vehicle, for example for autonomous driving functions, environmental monitoring, object detection, and the like.

In some cases, this method cannot be applied, for example, when the contour is circular. To avoid such cases, preferably, the detected contour is analyzed and checked for its shape in advance, and if an impermissible contour, such as a circular contour, is detected, calibration is aborted and/or calibration is limited to a selected group of rotation angles.

The reference contour KR is in particular the contour determined during the manufacture of the motor vehicle in the first test step of the camera device 3 or during the initialization of the camera system 2, as already mentioned above, and corresponds to the initially calibrated contour. Alternatively, the reference contour KR is determined virtually, for example, in that the contour is calculated using a 3D model as a function of the known mounting position and orientation of the camera device 3 and the body shape of the motor vehicle.

The present method is in particular used to perform a so-called online calibration, i.e., calibration while driving. The camera device can be arranged on the motor vehicle as in the present exemplary embodiment or also on a truck, robot, vehicle, or the like. The method can also be carried out for camera systems comprising one or more static or stationary cameras.

If a deviation of the detected contour from the reference contour is detected, for example which exceeds a specified limit value, an error message is output, for example which leads to the driver of the motor vehicle being notified via a fault system and/or the camera being reported as “defective” so that it is replaced in a later step.

Preferably, the correction values are determined using a median filter or a histogram. In particular, the determined correction values are compared to specifiable threshold values, wherein if a threshold value is exceeded or if no correction value is determined, a degenerative decalibration of the camera device 3 is determined to exist to an extent that a replacement or a physical correction of the camera device is necessary. In this case, the driver of the motor vehicle or a repair shop is then notified of the error in order to cause maintenance or replacement of the camera device 3.

While in the present exemplary embodiment the movable work system 1 is configured as a motor vehicle, according to a further exemplary embodiment, the work system 1 is configured as a robot, for example for a storage, supply, or assembly system. Instead of a body contour, a housing contour of the robot is then determined in the image recorded by the camera device 3.

What is claimed is:

1. A method for operating a camera system of a work system, the camera system including at least one camera device arranged on the work system, the method comprising:
capturing at least one image using the at least one camera device;
detecting a detected contour in the at least one image as being stationary relative to the at least one camera device;
projecting the detected contour onto a spherical surface;
determining a comparison by comparing the detected contour to a reference contour projected onto the spherical surface; and
calibrating the at least one camera device based on the comparison.

2. The method according to claim 1, further comprising:
detecting a predetermined contour in the at least one image as a stationary contour.

3. The method according to claim 1, wherein:
the work system is a motor vehicle having a housing and/or defining a body contour, and
at least one of the housing and the body contour is captured in the at least one image as a stationary contour.

4. The method according to claim 3, further comprising:
detecting a plurality of image areas of the at least one image using a trained deep learning method; and
detecting the stationary contour as a boundary between at least two adjacent image areas of the plurality of image areas.

5. The method according to claim 4, wherein the plurality of image areas are detected using semantic segmentation.

6. The method according to claim 3, further comprising:
capturing a plurality of images using the at least one camera device, the at least one image included in the plurality of images;
comparing pixels from images of the plurality of images to each other to differentiate a plurality of fixed pixels from a plurality of moving pixels; and
detecting the stationary contour as a series of fixed pixels of the plurality of fixed pixels adjacent to the plurality of moving pixels.

7. The method according to claim 1, further comprising:
determining a pitch angle of the at least one camera device, a roll angle of the at least one camera device, and a yaw angle of the at least one camera device based on the comparison; and
using the pitch angle, the roll angle, and the yaw angle in the calibrating of the at least one camera device.

8. The method according to claim 7, wherein the detected contour and the reference contour are made to match on the spherical surface by changing the pitch angle, the roll angle, and/or the yaw angle in the calibrating of the at least one camera device.

9. The method according to claim 1, further comprising:
prior to the calibrating, checking a shape of the detected contour; and
aborting the calibrating when the shape of the detected contour is a circular shape.

10. A control system for a camera system of a work system, comprising:
a processor configured to perform the method according to claim 1.

11. A camera system, comprising:
at least one camera device; and
a control system according to claim 10 and operably connected to the at least one camera device.
